(19) United States
(12) Patent Application Publication
(10) Pub. No.: US 2007/0098356 A1
(43) Pub. Date: May 3, 2007

(54) Data processor

(76) Inventors: Kenji Morimoto, Takarazuka-shi (JP); Toshiya Noritake, Daito-shi (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/553,508

(22) PCT Filed: Apr. 22, 2004
(86) PCT No.: PCT/JP04/05831

§ 371 Date: Oct. 14, 2005

(30) Foreign Application Priority Data
Apr. 23, 2003 (JP) 2003-118249

(51) Int. Cl. H04N 5/91

(52) U.S. Cl. 386/68

(57) ABSTRACT

A data processor includes: a stream extracting section for acquiring a first data stream and then a second data stream; a packet inserting section, which makes a dummy packet, having a dummy identifier that is different from any of the identifiers of packets in a stream, and which inserts the dummy packet between the last packet of the first data stream and the first packet of the second data stream; a splitting section for splitting content data into respective types according to the packet identifiers and inserting error data, which is different from the content data, upon the detection of the dummy identifier; and a decoder, which plays back the content data of the data stream on the basis of a playback unit and, on detecting the error data, discards incomplete content data at the end of the first data stream and a portion of the content data of the second data stream up to the first header thereof such that those content data are not played back.

### TECHNICAL FIELD

The present invention relates to a technique of playing back video and/or audio from a data stream. More particularly, the present invention relates to a technique that can be used effectively to play back continuously either multiple portions of the same data stream or a plurality of data streams.

### BACKGROUND ART

Recently, as digital technologies have been developed, data representing a video or audio content is more and more often encoded according to an MPEG or any other standard and stored as an encoded data stream on a storage medium such as an optical disk or a hard disk. Meanwhile, as the storage technology has been developed, various techniques of playing back an encoded data stream from such a storage medium have been proposed and have just started to be introduced into actual products.

For example, Japanese Patent Application Laid-Open Publication No. 2002-281458 discloses a player for playing back an encoded data stream stored on a storage medium. Hereinafter, the configuration of this player will be described with reference to FIG. 1, which shows the arrangement of functional blocks in a conventional player. The storage medium 1 may be an optical disk, for example, and stores thereon a data stream of video, audio or any other data in a predetermined format.

The reading section 2 of this player is given a specified address on the storage medium 1 by a microcontroller 3 and reads out a data stream stored at that address. The reading section 2 makes error correction processing on the digital signal read out, thereby obtaining a read data stream. Next, a stream splitting section 4 splits the data stream into a video data stream and an audio data stream. The video data stream separated is input to a video decoder 6 by way of a video signal selecting switch 12a, a video data memory section 5, and another video signal selecting switch 12b. The video data memory section 5 includes two or more independent memory areas that can store data streams independently of each other. The video data stream is input to the video decoder 6 through one of those memory areas. On the other hand, the audio data stream, which has been separated by the stream splitting section 4, is input to an audio decoder 10 by way of an audio data memory section 9.

The video decoder 6 decodes the video data stream, converts it into a video signal, and outputs it through a video output terminal 8, while at the same time storing the decoded video on a frame data memory section 7. Meanwhile, the audio decoder 10 decodes the audio data stream, converts it into an audio signal, and outputs it through an audio output terminal 11.

The player may play back discontinuous data streams. A data stream gets stored on the storage medium 1 as a result of a series of operations that begins with start of write processing and ends with stop of that write processing. Accordingly, if the write processing has been carried out a number of times, at least two data streams are stored on the storage medium 1. In that case, if the user instructs the player to play back these data streams back to back, then the player has to play back the at least two discontinuous data streams continuously. Also, even in playing back multiple ranges of a single data stream continuously, if each of those ranges is regarded as one data stream, then the player also has to play back at least two discontinuous data streams continuously. The situation is typically encountered when the user made a play list to specify arbitrary playback ranges and paths for a single data stream.

Hereinafter, it will be described how the player carries out the processing of playing back discontinuous data streams. First, the player controls the video signal selecting switches 12a and 12b, thereby getting a first data stream transmitted to, and decoded by, the video decoder 6 by way of one of the memory areas of the video data memory section 5. As soon as the video decoder 6 has decoded the first data stream, the microcontroller 3 turns the video signal selecting switches 12a and 12b. Then, a second data stream read out next is transmitted to the video decoder 6 by way of the other memory area of the video data memory section 5. Consequently, the video decoder 6 can start decoding the second data stream on decoding the first data stream, i.e., can decode the two data streams continuously.

A conventional player like this, however, inevitably needs an increased amount of hardware and also requires a complicated control. More specifically, in such a player, at least two independent memory areas need to be provided for the video data memory section to store the data streams separately. The player also needs the input and output video signal selecting switches to switch the memory areas. The microcontroller has to carry out a switching control on those switches.

An object of the present invention is to play back a number of discontinuous data streams continuously using a simple configuration and control without providing any additional memory area or video signal selecting switch. A secondary object of the present invention is to minimize playback disturbance at a discontinuity point.

### DISCLOSURE OF INVENTION

A data processor according to the present invention plays back a content while acquiring a data stream including content data. The data stream includes a plurality of packets, each packet being consisted of the content data and an identifier to show the type of the content data. A portion of the content data corresponding to the top of a playback unit has a header showing the identity of the playback unit. The data processor includes: a stream extracting section for acquiring a first data stream and then a second data stream; a packet inserting section, which makes a dummy packet, having a dummy identifier that is different from any of the identifiers of the packets, and which inserts the dummy packet between the last packet of the first data stream and the first packet of the second data stream; a splitting section for splitting the content data into respective types according to the identifiers and inserting error data, which is different from the content data, upon the detection of the dummy identifier; and a decoder, which plays back the content data on the basis of the playback unit and, on detecting the error data, discards incomplete content data at the end of the first data stream and a portion of the content data of the second data stream up to the first header thereof such that those content data are not played back.

An error code, representing an error, may be predefined for the data stream, and the splitting section may insert the error code as the error data.

The splitting section may further insert a bit string of zeros having a predetermined length as the error data. When detecting one of the error code and the bit string, the decoder may determine that the error data has been detected.

The data representing the content may have been encoded by a variable length coding technique and may be included in the data stream. The splitting section may insert a bit string, of which the bit length is equal to or greater than a maximum code length used in the variable length coding technique.

The content may at least include video. The splitting section may insert a bit string, of which the bit length is equal to or greater than a maximum code length used in the variable length coding technique for video.

The stream extracting section may acquire the first and second data streams, each being consisted of transport stream packets.

The stream extracting section may acquire mutually different portions of a single data stream, representing the same content, as the first and second data streams, respectively.

The stream extracting section may acquire the first and second data streams from a storage medium.

The stream extracting section may acquire the first and second data streams that have been broadcast.

A data processing method according to the present invention is designed to play back a content while acquiring a data stream including content data. The data stream includes a plurality of packets, each packet being consisted of the content data and an identifier to show the type of the content data. A portion of the content data corresponding to the top of a playback unit has a header showing the identity of the playback unit. The data processing method includes the steps of: acquiring a first data stream and then a second data stream; making a dummy packet, having a dummy identifier that is different from any of the identifiers of the packets; inserting the dummy packet between the last packet of the first data stream and the first packet of the second data stream; splitting the content data into respective types according to the identifiers; inserting error data, which is different from the content data, upon the detection of the dummy identifier; playing back the content data on the basis of the playback unit; and discarding incomplete content data at the end of the first data stream and a portion of the content data of the second data stream up to the first header thereof on detecting the error data.

An error code, representing an error, may be predefined for the data stream, and the step of inserting the error data may include inserting the error code as the error data.

The step of inserting the error data may further include inserting a bit string of zeros having a predetermined length as the error data. The step of discarding may include determining that the error data has been detected on detecting one of the error code and the bit string.

The data representing the content may have been encoded by a variable length coding technique and be included in the data stream. The step of inserting the error data may include inserting a bit string, of which the bit length is equal to or greater than a maximum code length used in the variable length coding technique.

The content may at least include video. The step of inserting the error data may include inserting a bit string, of which the bit length is equal to or greater than a maximum code length used in the variable length coding technique for video.

The step of acquiring may include acquiring the first and second data streams, each being consisted of transport stream packets.

The step of acquiring may include acquiring mutually different portions of a single data stream, representing the same content, as the first and second data streams, respectively.

The step of acquiring may include acquiring the first and second data streams from a storage medium.

The step of acquiring may include acquiring the first and second data streams that have been broadcast.

### BRIEF DESCRIPTION OF DRAWINGS

FIG. 1 shows the arrangement of functional blocks in a conventional player.

FIG. 2 shows the data structure of an MPEG-2 transport stream 20.

FIG. 3(a) shows the data structure of a video TS packet 30 and FIG. 3(b) shows the data structure of an audio TS packet 31.

Portions (a) to (d) of FIG. 4 show a stream correlation to be established when video pictures are played back from video TS packets.

Portion (a) of FIG. 5 shows the arrangement order of picture data, and portion (b) of FIG. 5 shows the order in which the pictures are played back and output.

FIG. 6 shows the arrangement of functional blocks in a player 100.

FIG. 7 shows a correlation between a TS processed by the player 100 and an ES obtained from the TS.

FIG. 8 shows the arrangement of functional blocks in a stream splitting section 64.

FIG. 9 shows the arrangement of data before and after a stream switching point.

FIG. 10 shows the arrangement of functional blocks in a video decoder 66.

FIG. 11 is a flowchart showing the procedure of the processing done by the player 100.

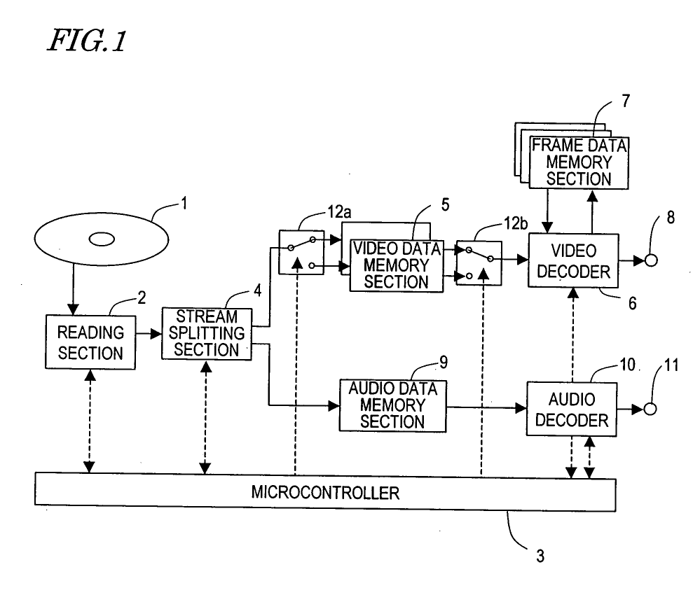

### BEST MODE FOR CARRYING OUT THE INVENTION

Hereinafter, a player will be described as a preferred embodiment of a data processor according to the present invention with reference to the accompanying drawings.

First of all, the data structure of a data stream to be processed by a player according to this preferred embodiment will be described. After that, the configuration and operation of the player will be described.

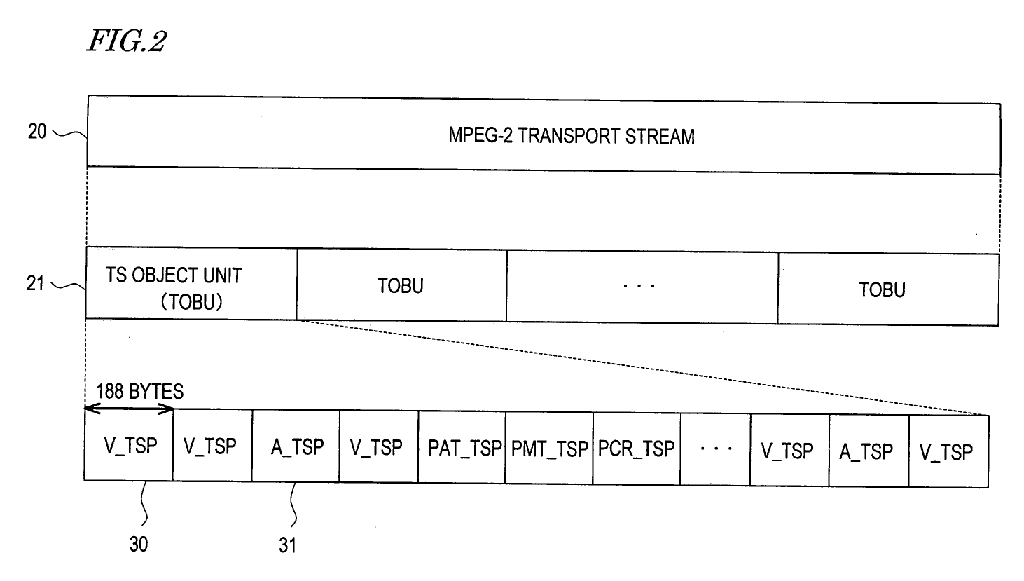

FIG. 2 shows the data structure of an MPEG-2 transport stream 20. The MPEG-2 transport stream 20 (which will be referred to herein as “TS 20”) includes a plurality of TS object units (TOBUs) 21, each of which includes at least one transport packet (TS packet). Examples of those TS packets include a video TS packet (V_TSP) 30 in which compressed video data is stored, an audio TS packet (A_TSP) 31 in which compressed audio data is stored, a packet (PAT_TSP) in which a program association table (PAT) is stored, a packet (PMT_TSP) in which a program map table (PMT) is stored, and a packet (PCR_TSP) in which a program clock reference (PCR) is stored. Each of these packets has a data size of 188 bytes.

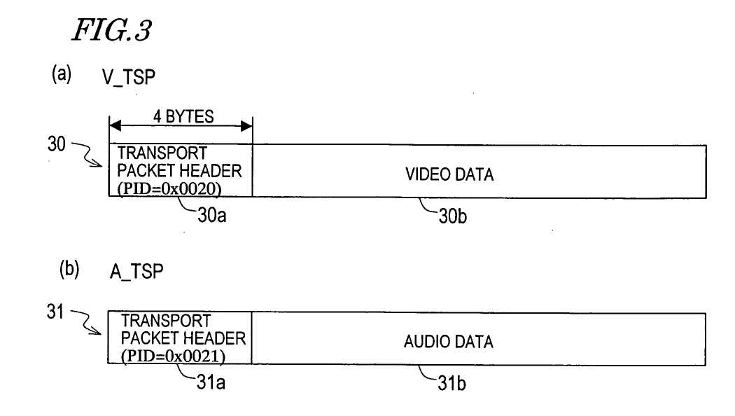

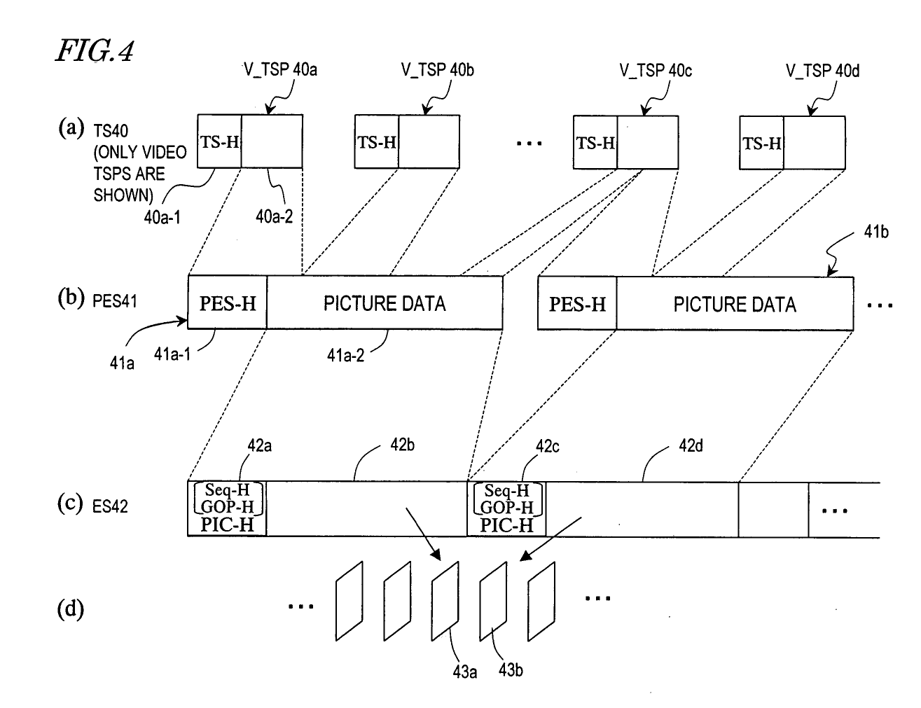

Hereinafter, the video TS packets and audio TS packets, which are relevant to the processing of the present invention, will be described. FIG. 3(a) shows the data structure of a video TS packet 30. The video TS packet 30 includes a transport packet header 30a of 4 bytes and video data 30b of 184 bytes. On the other hand, FIG. 3(b) shows the data structure of an audio TS packet 31. The audio TS packet 31 also includes a transport packet header 31a of 4 bytes and audio data 31b of 184 bytes.

As can be seen from this example, a TS packet is usually made up of a transport packet header of 4 bytes and elementary data of 184 bytes. In the packet header, a packet ID (PID) showing the type of that packet is described. For example, the PID of a video TS packet is 0x0020, while that of an audio TS packet is 0x0021. The elementary data may be content data such as video data or audio data or control data for controlling the playback. The type of the data stored there changes according to the type of the packet. It should be noted that the data memory area of a TS packet, following the TS packet header, is called a “payload” when content data such as video data or audio data is stored there and an “adaptation field” when control data is stored there, respectively. The prime feature of the processing of this preferred embodiment lies in the processing that uses the payload of a TS packet.

FIGS. 2, 3(a) and 3(b) show an exemplary data structure of a transport stream. However, this data structure is equally applicable to packs included in a program stream because data also follows a packet header in a pack. A “pack” is known as an exemplary form of a packet. Nevertheless, the pack is different from the packet in that a pack header is additionally provided before the packet header and that the pack has a data size of 2,048 kilobytes.

The following preferred embodiment of the present invention will be described herein as being applied to video processing.

Portions (a) to (d) of FIG. 4 show a stream correlation to be established when video pictures are played back from video TS packets. As shown in portion (a) of FIG. 4, this TS 40 includes video TS packets 40a through 40d. Although the TS 40 may include other packets, only those video TS packets are shown here. A video TS packet can be easily identifiable by the PID stored in its header 40a-1.

A packetized elementary stream is made up of the video data of respective video TS packets such as the video data 40a-2. Portion (b) of FIG. 4 shows the data structure of a packetized elementary stream (PES) 41. The PES 41 includes a plurality of PES packets 41a, 41b, etc. The PES packet 41a is made up of a PES header 41a-1 and picture data 41a-2. These data are stored as the video data of the video TS packets.

The picture data 41a-2 includes the data of respective pictures. An elementary stream is made up of those picture data 41a-2. Portion (c) of FIG. 4 shows the data structure of an elementary stream (ES) 42. The ES 42 includes multiple pairs of picture headers and frame or field data. It should be noted that although the “picture” is generally used as a term that may refer to either a frame or a field, the “picture” is supposed herein to be a frame. The “picture” is the smallest playback unit of video.

In the picture header 42a shown in portion (c) of FIG. 4, a picture header code, showing the picture type of frame data 42b that follows, is described. A picture header code, showing the picture type of frame data 42d, is described in the picture header 42c. The “type” is one of an I-picture (I-frame), a P-picture (P-frame) and a B-picture (B-frame). If the type shows this is an I-frame, its picture header code may be “00_{—}00_{—}01_{—}00_{—}00_{—}8b” according to hexadecimal notion, for example.

It should be noted that either a sequence header (Seq-H) or a GOP header (GOP-H) may be further described before the picture header. The GOP header (GOP-H) is a header to identify a playback unit consisting of a plurality of pictures that begins with an I-picture (i.e., a group of pictures (GOP)). On the other hand, the sequence header (Seq-H) is a header to identify a playback unit including more than one GOPs (i.e., a sequence).

The frame data 42b, 42d, etc. is data corresponding to a single frame, which may consist of either that data only or that data and preceding/succeeding data to be decoded before and/or after the former data. For example, portion (d) of FIG. 4 shows a picture 43a consisting of the frame data 42b and a picture 43b consisting of the frame data 42d.

According to the bidirectional coding method adopted in the main profile of the MPEG-2 standard, video data is classifiable into data that can make one complete picture by itself (i.e., I-picture data) and data that cannot make one complete picture by itself but can make it by reference to the data of another picture (i.e., P-picture data or B-picture data).

More specifically, in some cases, all P- and B-pictures within a GOP may be arranged so as to refer to only I- or P-pictures within the same GOP (a GOP with such a data structure is called a “closed GOP”). In other cases, some of the B-pictures belonging to a GOP may refer to I- or P-pictures within its previous GOP (a GOP with such a data structure is called an “open GOP”).

The arrangement and presentation order of picture data are also defined in various manners. Hereinafter, exemplary data arrangement and presentation order of respective pictures to achieve the presentation order of the latter GOP (i.e., open GOP) will be described with reference to portions (a) and (b) of FIG. 5.

Portion (a) of FIG. 5 shows an arrangement order of picture data, while portion (b) of FIG. 5 shows an order in which pictures are played back and output. In portions (a) and (b) of FIG. 5, “I”, “P” and “B” denote I-pictures, P-pictures and B-pictures, respectively. The data of these pictures makes up the ES 42 shown in portion (c) of FIG. 4. In portion (a) of FIG. 5, the I-picture 54 through the B-picture 60, which is the previous picture of the next I-picture, form one GOP.

As can be seen from portions (a) and (b) of FIG. 5, the arrangement order of the picture data is different from the presentation order thereof. For example, although the picture data of the I-picture 54 is arranged before those of the B-pictures 55 and 56, the I-picture 54 is presented after the B-pictures 55 and 56 have been presented. The same statement applies to the relationship between the picture data of the P-picture 57 and those of the two B-pictures that follow the P-picture 57. That is to say, those two B-pictures are presented first, and then the P-picture 57 is presented.

In portion (a) of FIG. 5, the B-picture 55 is encoded based on differential data between the P-picture 53 to be referred to forward and the I-picture 54 to be referred to backward in the presentation order. The same statement applies to the next B-picture 56, too. In this example, each of these B-pictures 55 and 56 refers to a P-picture of the previous GOP. In decoding these B-pictures 55 and 56, the picture data of their original pictures 53 and 54 are referred to. The original pictures to be referred to are called “reference pictures”. The picture data of each reference picture is stored in a buffer, for example, and referred to when another picture is decoded.

Also, the P-picture 57 is encoded based on the difference from the last I-picture 54. The P-picture 58 is encoded based on the difference from the last P-picture 57. In decoding the P-picture 58, the picture data of the P-picture 57, which is its reference picture, is needed.

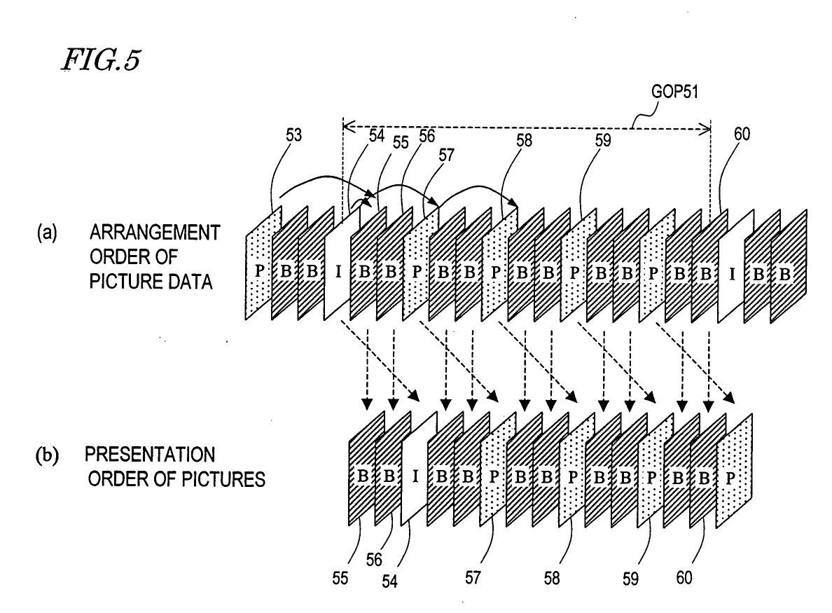

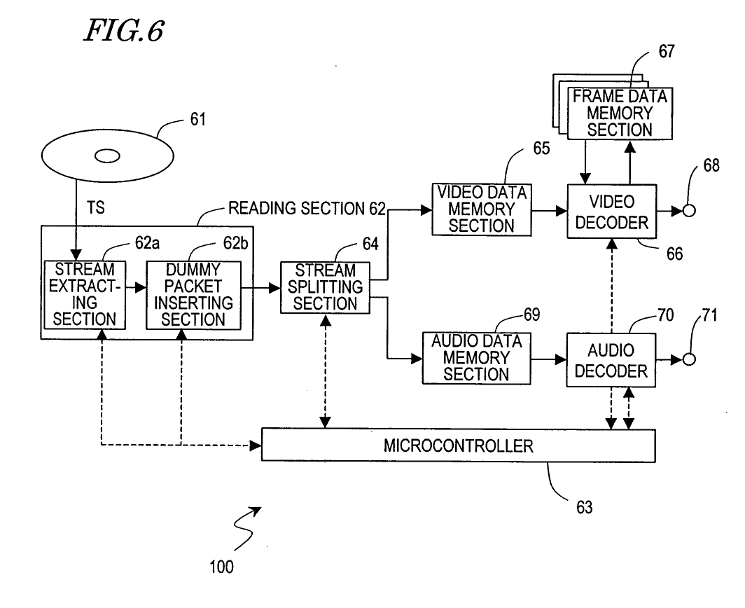

Hereinafter, the configuration and operation of a player according to this preferred embodiment will be described with reference to FIG. 6. As mentioned above, as for the player of this preferred embodiment, the functions of respective components thereof will be described as being mainly applied to video processing. Also, in this preferred embodiment, the storage medium is supposed to be a hard disk.

The player acquires the TS packets, carries out system decoding on the acquired TS packets down to the ES 42 (see portion (c) of FIG. 4), and then outputs decoded pictures. To describe normal decoding and presentation processing, the following preferred embodiment will be described as adopting the “closed GOP” data structure in which every picture can be made of the data included in the same GOP.

FIG. 6 shows the arrangement of functional blocks in the player 100. The player 100 includes a hard disk 61, a reading section 62, a microcontroller 63, a stream splitting section 64, a video data memory section 65, a video decoder 66, a frame data memory section 67, a video output terminal 68, an audio data memory section 69, an audio decoder 70, and an audio output terminal 71. A drive including a motor for spinning the hard disk 61 and a magnetic head is actually needed to read and write data from/on the hard disk 61 but is omitted in FIG. 6. Optionally, the non-removable hard disk 61 may be replaced with some removable storage medium such as a Blu-ray disk (BD). In that case, the storage medium does not have to be a component belonging to the player 100.

Under the control of the microcontroller 63, the player 100 can play back a content such as video or audio while acquiring TS, including content data representing that content, from the hard disk 61. In the following description, just a single TS is supposed to be stored on the hard disk 61 and a method of playing back some range of the TS and then another discontinuous range thereof will be described as an example. This situation is typically encountered when the user made a play list to specify arbitrary playback ranges and paths for a single data stream. Those playback ranges form respective portions of a single TS, strictly speaking, but may be treated as separate TS (which will be referred to herein as “TS-A” and “TS-B”), too.

Hereinafter, the function of this player 100 will be outlined. Specifically, the reading section 62 of the player 100 acquires TS-A and then TS-B from the hard disk 61. Next, the reading section 62 makes a dummy packet, having a dummy identifier that is different from any of the packet identifiers (PIDs) of the respective TS, and inserts it between the last packet of the TS-A and the first packet of the TS-B. The stream splitting section 64 splits the content data into video and audio elementary data by sorting the packets into respective types according to the packet identifiers (PIDS). Also, upon the detection of the dummy identifier, the stream splitting section 64 inserts error data, which is different from the content data. The decoders 66 and 70 play back the content data on the basis of a playback unit. On detecting the error data, the decoders 66 and 70 discard incomplete content data at the end of the TS-A and a portion of the content data of the TS-B up to the first header thereof and never play back those data. In this manner, the boundary point between the two data streams (i.e., TS-A and TS-B) can be conveyed to the decoders 66 and 70, just as intended.

The respective components of the player 100 may function as follows. It should be noted that these components operate in accordance with the instruction given by the microcontroller 63.

The reading section 62 includes a magnetic head, a signal equalizer, an error corrector (none of which is shown) as its hardware components. The reading section 62 includes a stream extracting section 62a and a dummy packet inserting section 62b. The stream extracting section 62a receives a specified address on the hard disk 61 from the microcontroller 3 and reads out data from that address. Thereafter, the stream extracting section 62a makes an error correction on that data, thereby obtaining TS (including TS-A, TS-B and so on).

The dummy packet inserting section 62b makes a dummy packet, having a dummy identifier that is different from the packet identifier (PID) of a video TS packet or an audio TS packet, and inserts the dummy packet between the TS-A and the TS-B.

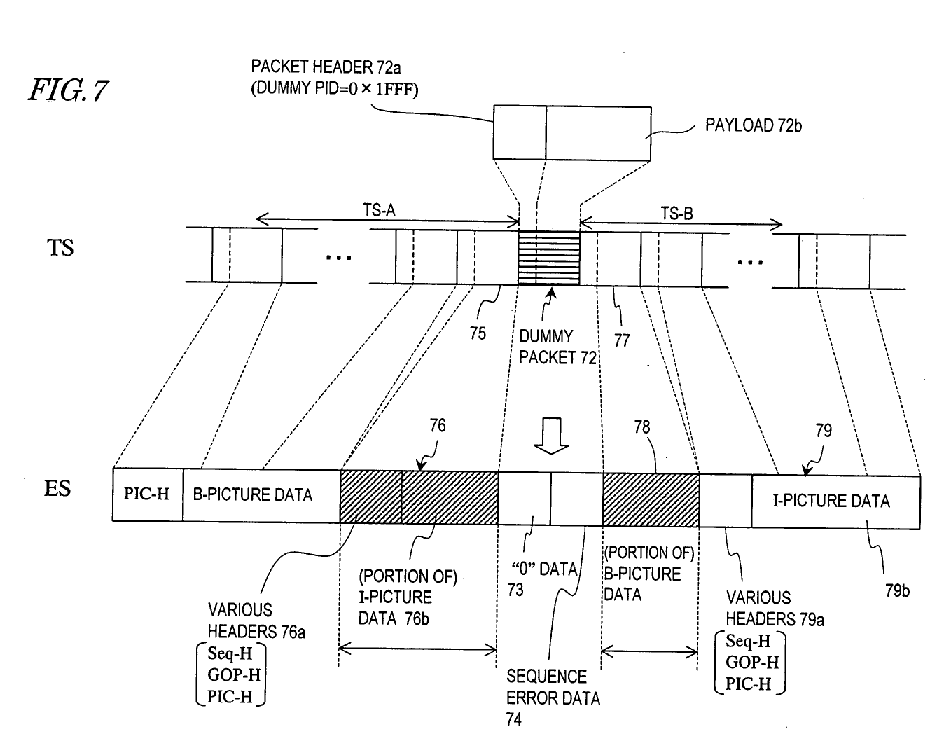

Hereinafter, the dummy packet will be described with reference to FIG. 7, which shows a correlation between a TS being processed by the player 100 and an ES obtained from the TS. Looking at the TS shown in FIG. 7, it can be seen that the dummy packet 72 is inserted between the last packet 75 of the TS-A and the first packet 77 of the TS-B. FIG. 7 also shows the data structure of the dummy packet 72. The dummy packet 72 is made up of a packet header 72a and a payload 72b and has a data structure similar to that of the video TS packet 30 (see portion (a) of FIG. 3) or that of the audio TS packet 31 (see portion (b) of FIG. 3).

In the packet header 72a, an identifier (PID) to identify the dummy packet 72 from the other packets is described. This identifier (PID) may be 0x1FFF, for example, which is different from the identifier (PID) of the video or audio TS packet described above. Dummy data, which is a data sequence with a predetermined pattern, is stored in the payload 72b. The dummy data is not a significant data sequence and is not supposed to be played back, either. Accordingly, a NULL packet, which is ordinarily used just for stuffing purposes, may be used as the dummy packet, and the PID of the NULL packet and a particular pattern that follows the PID may be included as the dummy packet.

However, if the dummy packet 72 is inserted between the last packet 75 of the TS-A and the first packet 77 of the TS-B, then the following problem arises. Specifically, as is clear from the illustration in portions (a) through (d) of FIG. 4 and their associated descriptions, the PES header, picture header, frame data and so on are stored independently as the video data of each video TS packet. Suppose the data required for playing back a single frame has been distributed in a number N of video TS packets, for example. In that case, if the dummy packet 72 were inserted before the N video TS packets of the TS-A have been acquired fully, then that frame of the TS-A would not have every data required and could not be played back successfully sometimes. As shown in the lower portion of FIG. 7, the ES 76 obtained from the TS-A includes non-playable I-picture data 76b. Such a non-playable picture will be referred to herein as “incomplete” data.

In the same way, if the video TS packet of the TS-B, which follows the dummy packet 72 inserted, were one of N video TS packets of the TS-B being transmitted, then a portion of the frame data included in the video TS packets that have already been transmitted could not be acquired and non-playable, either. In the lower portion of FIG. 7, shown is non-playable B-picture data 78 in the ES 79 obtained from the TS-B.

Also, the TS packets have a fixed data length of 188 bytes. Accordingly, if the data required for playing back a single frame were distributed in N video TS packets, then one of the beginning and end of that frame may not match the boundary of the first TS packet or that of the N^{th} TS packet. For example, even if the last TS packet of the TS-A, which is just before the dummy packet 72 inserted, is the N^{th} TS packet, a portion of succeeding picture data (such as the I-picture data 76b in the ES shown in FIG. 7) may be included in the video data of that packet. That portion of the picture data is not played back and the data is incomplete. In the same way, incomplete picture data, which is not playable up to a certain midpoint, may be included in the first TS packet of the TS-B, which follows the dummy packet 72 inserted, just like the B-picture data 78b in the ES shown in FIG. 7. It should be noted that the “N” value usually changes from one picture data to another.

If such non-playable frame data were subjected to playback processing, then the frame picture presented would be disturbed or a decoding error might occur.

Thus, to avoid such a problem, the stream splitting section 64 and video decoder 66 perform processing that is designed so as not to play back the incompletely acquired frame data by mistake.

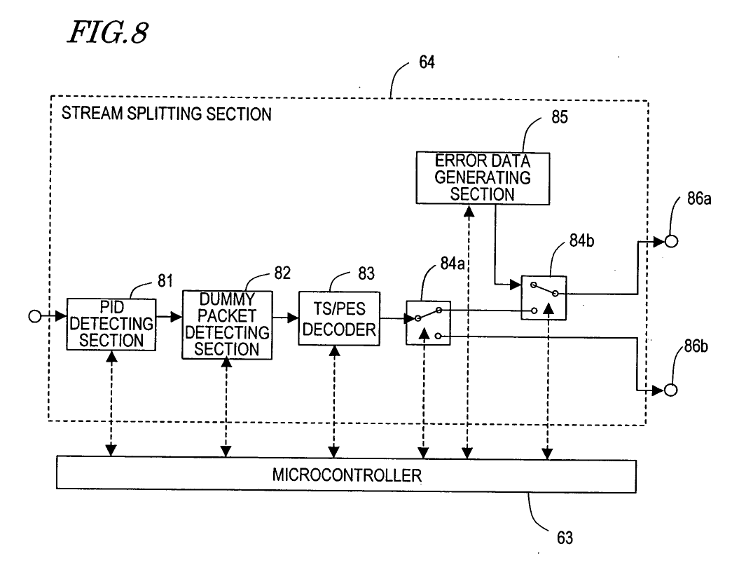

Hereinafter, the configuration and function of the stream splitting section 64 will be described with reference to FIG. 8, which shows the arrangement of functional blocks in the stream splitting section 64. The stream splitting section 64 includes a PID detecting section 81, a dummy packet detecting section 82, a TS/PES decoder 83, switches 84a, 84b and an error data generating section 85.

The PID detecting section 81 receives a series of data streams, consisting of the TS-A, the dummy packet 72 and the TS-B as shown in the upper portion of FIG. 7, and analyzes the packet headers of the respective packets, thereby detecting identifiers (PIDs). The identifiers (PIDs) detected are transferred to the microcontroller 63. Each packet has a unique identifier (PID) according to its type. Thus, the microcontroller 63 can detect, by the value of the identifier (PID), what type of data the given packet stores in its payload area. It should be noted that the PID detecting section 81 can detect not only the PIDs of the video TS packets 30, audio TS packets 31 and dummy packet 72 but also the respective identifiers (PIDs) of the program association table packet (PAT_TSP) and program map table packet (PMT_TSP) shown in FIG. 2.

Next, when the dummy PID is detected, the dummy packet detecting section 82 analyzes the payload of that packet, thereby determining whether or not particular dummy data is present in that payload and whether or not that packet is the dummy packet 72. In this manner, the dummy packet 72 can be detected just as intended. Optionally, no matter whether the dummy PID has been detected or not, the dummy packet detecting section 82 may detect the dummy data. Such processing is particularly effective in a situation where the dummy packet cannot be detected just by the identifier (PID). If the dummy data is present there, the dummy packet detecting section 82 senses having detected the dummy packet 72. The detection of the dummy data 72 shows that the data stream is discontinuous at that packet location. When notified of the detection of the dummy packet 72 by the dummy packet detecting section 82, the microcontroller 63 can sense that the TS-A is switched into the TS-B at that packet location.

Based on the data stored in the payloads of the video, audio and other TS packets, the TS/PES decoder 83 carries out system decoding down to the level of elementary streams and outputs the resultant data. However, the dummy data stored in the dummy packet 72 is not significant data and is not supposed to be played back as mentioned above. That is why the dummy data is output as it is without being decoded.

Next, it will be described how the TS/PES decoder 83 performs its processing on the video shown in portions (a) through (c) of FIG. 4, for example. Specifically, the TS/PES decoder 83 removes the packet headers from the video TS packets 40a through 40d to obtain their payloads. Also, if a PES header is present in any of those payloads, the TS/PES decoder 83 removes the PES header, too. In this manner, the TS/PES decoder 83 can obtain elementary data. As to the dummy packet on the other hand, the TS/PES decoder 83 removes the packet header and outputs the remaining dummy data as it is.

It should be noted that the processed data output by the TS/PES decoder 83 does not have to be the elementary stream 42 shown in portion (c) of FIG. 4. This is because any stream usually includes not only the video TS packets but also audio TS packets. The elementary stream 42 is obtained by storing it in the video data memory section 65 to be described later. An elementary stream for audio is also stored in the audio data memory section 69.

In accordance with the instruction given by the microcontroller 63, which has been notified of the detection of the identifiers (PIDs) by the PID detecting section 81, the switch 84a turns data transmission paths. Specifically, if the identifier (PID) of the TS packet being processed shows that packet is a video TS packet, then the switch 84a selects a path that passes the data to the switch 84a. On the other hand, if the PID shows that packet is an audio TS packet, then the switch 84a takes a path that passes the data to a terminal 86b. The terminal 86b is connected to the audio data memory section 69. The data is stored as an audio elementary stream on the audio data memory section 69.

The switch 84b also turns data transmission paths in accordance with the instruction given by the microcontroller 63. The switch 84b normally selects a path that passes the elementary data, which has been transmitted from the TS/PES decoder 83 by way of the switch 84a, to a terminal 86a. However, if the dummy packet detecting section 82 has detected the dummy packet, then the switch 84b takes a path that passes the data from the error data generating section 85 to the terminal 86a as long as the dummy data is being input to the switch 84b. The terminal 86a is connected to the video data memory section 65. The data is stored as a video elementary stream on the video data memory section 65.

The error data generating section 85 inserts “0” data, which consists of zeros only and has a predetermined data length, and sequence error data (sequence_error), which has some particular value and another predetermined data length. For example, the data length of the “0” data may be equal to or greater than the maximum length of an possible variable length code (VLC) to be described later. When the switch 84b is turned thereto, the error data generating section 85 outputs the “0” data and the sequence error data in this order.

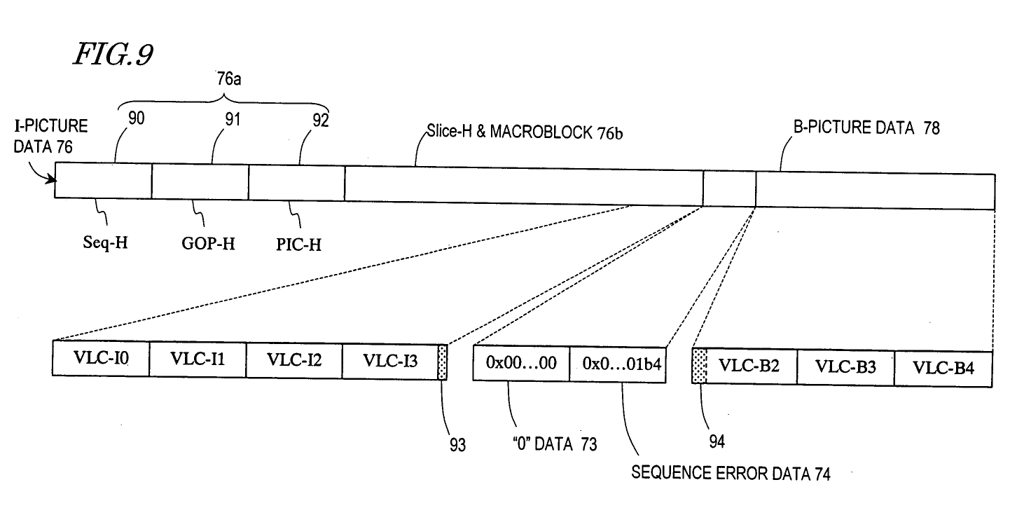

Next, the elementary stream (ES) obtained by the stream splitting section 64 will be described with reference to FIGS. 7 and 9. The lower portion of FIG. 7 shows an ES obtained from TS. It should be noted, however, that only an ES for video is shown and the data structure thereof is as stored in the video data memory section 65.

Suppose the ES has been formed by being output from the stream splitting section 64 rightward (i.e., from left to right) in FIG. 7. In the ES, first, data about a B-picture (i.e., its picture header (PIC-H)) is followed by B-picture data. The B-picture data is followed by an I-picture. The various types of headers 76a include not only the I-picture header but also the sequence header, GOP header and so on.

The I-picture data 76b is arranged next to the various types of headers 76a. However, the I-picture data that has been stored in the video TS packet 75 is part of the data that makes up one complete I-picture, not all of that data. The header and picture data of an I-picture may be stored in 20 video TS packets, for example. Accordingly, it is quite imaginable that the TS-A is switched into the TS-B before the data that makes up a single I-picture is acquired fully.

In the range which follows the I-picture data 76b and in which the dummy packet 72 has been inserted, the “0” data 73 and the sequence error data 74 are now arranged. To sense the presence of the data 73 and/or the data 74 at a location means that the TS-A is switched into the TS-B at this particular location. The location where the data 73 and 74 are present will be referred to herein as a “stream connection point” for convenience sake.

The sequence error data 74 at the stream connection point is followed by incomplete picture data 78 that forms a part of the TS-B. This B-picture data 78 does not always include the picture header of a B-picture. The reason is that since the TS-A may be switched into the TS-B at an arbitrary location thereof, a packet storing only the elementary data may be present.

In the example shown in FIG. 7, the B-picture data 78 of the TS-B is followed by various types of headers 79a and I-picture data 79b. This I-picture data 79b can make one full I-picture to present. It should be noted that the picture data to be transmitted after this I-picture data 79b (e.g., B-picture data) may be played back by reference to the I-picture data 79b, for example.

The partial I-picture data 76b and partial B-picture data as indicated by the hatching in FIG. 7 cannot be presented by themselves. This is because no data can be presented as one full picture unless all necessary picture data has been put together. Consequently, data that is not available for playback is present before and after the location where the “0” data 73 and the sequence error data 74 are present (i.e., the stream connection point).

Next, the data structure at the stream connection point will be described in detail with reference to FIG. 9, which shows the arrangement of data around the stream connection point. Specifically, the data shown in FIG. 9 begins with the I-picture data 76b that is not available for playback and ends with the B-picture data 78 with the “0” data 73 and sequence error data 74 interposed between them. At the top of the I-picture data 76b, the various types of headers 76a, including the sequence header (with sequence extension data) 90, GOP header 91 and picture header 92, are present, and then followed by a slice header and macroblock 76b as the I-picture data. The slice header and macroblock 76b, of which the I-picture data is made up, include variable length codes (VLCs), which are encoded video data. In FIG. 9, variable length codes VLC-I0, I1, I2 and I3 are shown. The last TS packet of the TS-A ends with the next variable length code VLC 93. The rest of the variable length code VLC 93 should have been stored in the next video TS packet (not shown) of the TS-A but is no longer present because the TS-A has already been switched into the TS-B.

After the variable length code VLC 93, arranged are the “0” data 73 and the sequence error data 74. In FIG. 9, a gap is illustrated between the variable length code VLC 93 and the “0” data 73 just for convenience sake. Actually, the variable length code VLC 93 and the “0” data 73 are arranged continuously.

Next, the B-picture data 78 of the TS-B is arranged. The top variable length code VLC 94 never functions as a variable length code actually. This is because the variable length code VKC 94 is only a portion of the variable length code and is non-decodable. The data that should have been present before the variable length code VLC 94 has already been transmitted before the TS-A is switched into this TS-B, and is no longer included in this stream. The variable length code VLC 94 is followed by variable length codes VLC-B2, B3 and B4, which are decodable independently.

The “0” data 73 and the sequence error data 74 are provided for the following reasons. Firstly, were it not for the “0” data 73 and the sequence error data 74, the variable length codes VLC 93 and VLC 94 would be combined together to form continuous data. Then, the combined data could be detected as a single variable length code VLC erroneously and the video decoder 66 as the next stage would cause a decoding error. That is why the sequence error data 74 is provided. The sequence error data 74 may be 0x00001b4, for example. Whenever this data is detected, it means that an error has been detected.

Suppose only the sequence error data 74 is provided with no “0” data 73 included. In some cases, the stream connection point could be located by the sequence error data 74 only. Without the “0” data 73, however, the previous variable length code VLC 93 and the sequence error data 94 would be combined together and might be detected as a single variable length code VLC erroneously. In other words, the sequence error data 74 could not be recognized properly. That is why the “0” data 73 is provided to avoid such an erroneous recognition. Nevertheless, it is also necessary to prevent a similar erroneous recognition from occurring when the variable length code VLC-I3 and the “0” data 73 are combined together. For that purpose, the data length of the “0” data 73 is defined equal to or greater than the maximum length of the possible variable length codes VLC. On receiving the “0” data 73, the video decoder 66 can sense that this is a non-existent variable length code.

By providing the “0” data 73 and the sequence error data 74, the video decoder 66 that follows can detect either a VLC error, caused by combining the variable length code VLC-I3 and the “0” data 73, or an error resulting from the sequence error data 74, at the stream connection point. Also, the video decoder 66 can find the connection point properly.

Next, the processing done by the video decoder 66 (see FIG. 6) will be described. The video decoder 66 sequentially reads and decodes the ES shown in FIG. 7 from the video data memory section 65. While storing resultant picture data (i.e., frame data) in the frame data memory 67, the video decoder 66 will output complete frame data through the video output terminal when such data is obtained.

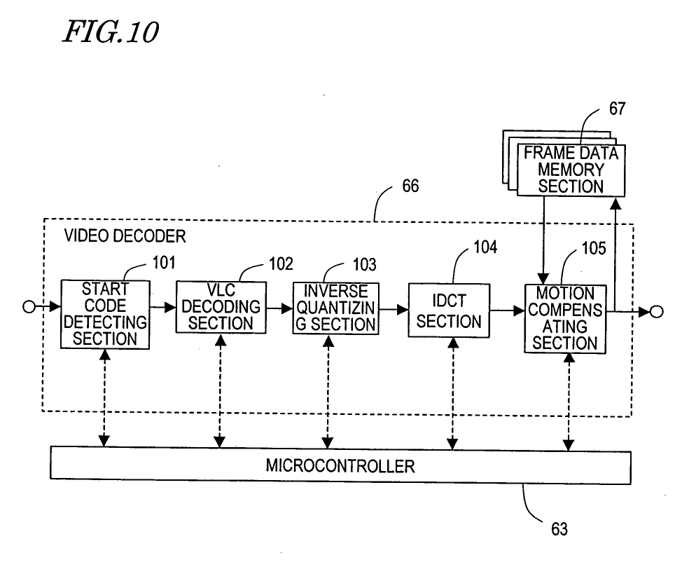

FIG. 10 shows the arrangement of functional blocks in the video decoder 66. The video decoder 66 includes a start code detecting section 101, a VLC decoding section 102, an inverse quantizing section 103, an inverse DCT (IDCT) section 104 and a motion compensating section 105.

The start code detecting section 101 receives a video ES through a video ES input terminal and detects the start code of a sequence header, a GOP header or an I-picture header, for example. Every start code begins with a 24-bit pattern of 0x000001. Accordingly, the start code detecting section 101 recognizes any of these various types of headers by the data that follows, and then decodes the information of the header detected. Also, the start code detecting section 101 is notified of the occurrence of a decoding error by the microcontroller 63. In response to this notice, the start code detecting section 101 searches for a sequence header, a GOP header and/or an I-picture header. On detecting the start code of at least one of these headers, the start code detecting section 101 notifies the microcontroller 63 of the detection of the start code.

The VLC decoding section 102 decodes the VLC data, thereby obtaining macroblock data. In an MPEG image compression method, data is encoded with VLC data to increase the data efficiency. In encoding the data, a decodable variable length code VLC is predefined. When receiving data with a non-defined pattern, the VLC decoding section 102 notifies the microcontroller 63 of the occurrence of a decoding error. The “0” data 73 and the sequence error data 74 described above are examples of such a “non-defined pattern”. The macroblock data is then subjected to inverse quantization processing by the inverse quantizing section 103, IDCT processing by the IDCT section 104, and motion compensation processing with a motion vector by the motion compensating section 105, respectively. Frame data is obtained as a result of these types of processing. The frame data is either stored in the frame data memory section 67 or output as it is through the output terminal if the frame data is I-picture data that needs no other picture data to refer to. The inverse quantization processing, IDCT processing and motion compensation processing are all well-known processes in the art, and detailed description thereof will be omitted herein.

Hereinafter, the processing done by the microcontroller 63 in connection with the start code detecting section 101 and the VLC decoding section 102 will be described. On receiving the notice that a decoding error has occurred, the microcontroller 63 discards the data from the previous picture header on such that the picture will not be presented. If the picture is an I-picture, the microcontroller 63 discards the data that follows its sequence header, i.e., incomplete content data at the end of the data stream. This data includes the picture data that has been decoded until then. Also, once received this notice, the microcontroller 63 will also discard the next data received until the start code detecting section 101 detects the next start code.

For example, in processing the data stream shown in FIG. 9, the VLC decoding section 102 notifies the microcontroller 63 of the occurrence of a decoding error on detecting either the “0” data 73 or the sequence error data 74. In response, the microcontroller 63 discards the data between the sequence header 90 and the variable length code VLC 93. Also, the microcontroller 63 further discards the data 94 and VLC-B2 through B4 to receive until the start code detecting section 101 detects the next sequence header.

This example is shown on the supposition that the B-picture is made by reference to the data of an I-picture, for example, which has already been transmitted before the B-picture data and which belongs to the same GOP. In an “open GOP”, however, even a fully transmitted B-picture also has data to be discarded. For instance, if the GOP header arranged just before the I-picture data 79b (see FIG. 7) shows that this is an “open GOP”, then the B-picture data that follows the I-picture may refer to an I-picture and/or a P-picture belonging to the previous GOP located just before the GOP including the B-picture. In that case, that B-picture data cannot be decoded only with the I-picture data 79b, and therefore may be discarded. Referring to portion (a) of FIG. 5, even if the data following that of the I-picture 54 has been acquired fully but if the decoding process should be started with the I-picture 54, then the data of the B-pictures 55 and 56 is discarded. As a result, the B-pictures 55 and 56 are not presented anymore. Thus, no decoding error should be caused by B-picture data that follows I-picture data and the presentation of an irregular picture can be avoided.

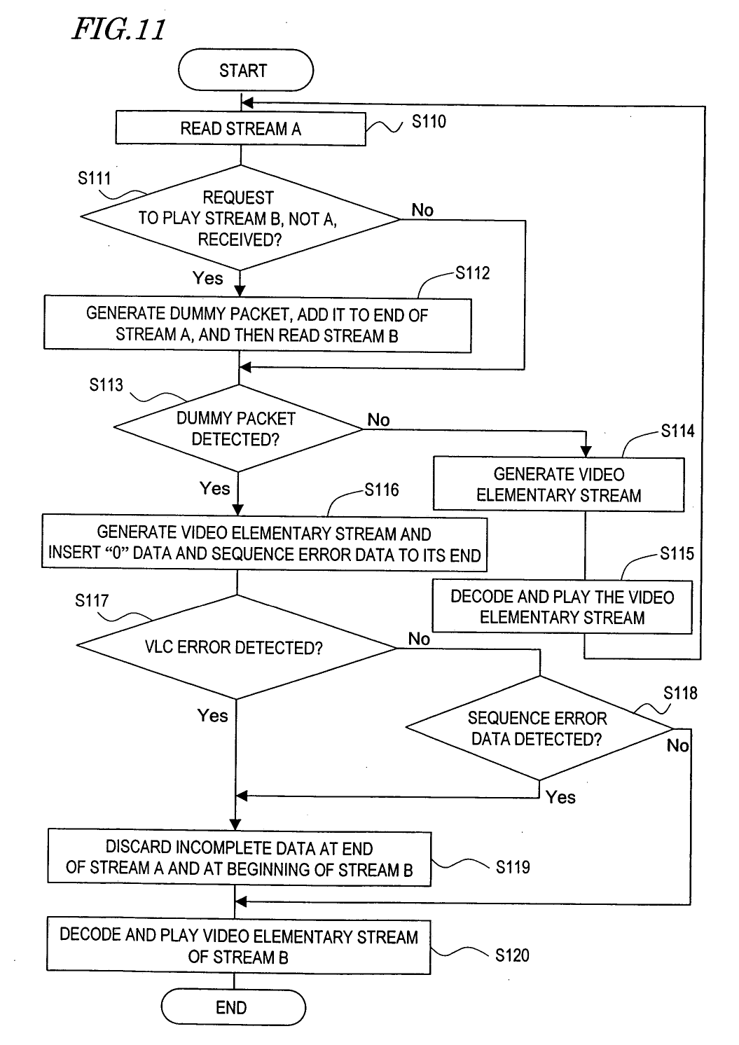

Hereinafter, it will be described with reference to FIG. 11 how the player 100 operates. FIG. 11 shows the procedure of processing done by the player 100. The processing shown in FIG. 11 is exemplary video processing and carried out under the control of the microcontroller 63. In FIG. 11, the processing steps S110, S111, S113, S114 and S115 are those of a normal stream playback process requiring no stream switching.

First, the normal stream playback process will be described. In Step S110, the stream extracting section 62a reads out Stream A (i.e., TS-A). Next, in Step S111, the microcontroller 63 determines whether or not it has received a request to play back Stream B, which is different from Stream A. In the normal playback process, the microcontroller 63 confirms the receipt of no such requests and the process advances to the next step S113, in which the dummy packet detecting section 82 determines whether or not it has detected any dummy packet. In this case, since there are no dummy packets, the process advances to the next step S114, in which the stream splitting section 64 generates video elementary data and stores its as a video elementary stream in the video data memory section 65. Next, in Step S115, the video decoder 66 decodes and plays back the video elementary stream. Thereafter, the process goes back to Step S110 again.

Next, a stream playback process with stream switching will be described. If the microcontroller 63 has confirmed the receipt of a request to play back Stream B, which is different from Stream A, in Step S111, then the process advances to Step S112, in which the dummy packet inserting section 62b makes a dummy packet and adds it to the end of Stream A. Thereafter, the stream extracting section 62a reads out Stream B and the process advances to the next step S113. Since the dummy packet detecting section 82 detects a dummy packet in Step S113, the process advances to Step S116, in which the TS/PES decoder 83 generates a video elementary stream for Stream A. Then, the error data generating section 85 inserts the “0” data and the sequence error data to the end of the video elementary stream. That data is stored in the video data memory section 65 and then read out by the video decoder 66.

Next, in Step S117, the VLC decoding section 102 determines whether or not it has detected any VLC error. If the answer is NO, the process advances to Step S118. On the other hand, if the answer is YES, the process advances to Step S119. In Step S118, the VLC decoding section 102 determines whether or not it has detected sequence error data. If the answer is YES, the process advances to Step S119. Otherwise, the process jumps to Step S120. By making these decisions a number of times in Steps S117 and S118, the connection point can be detected just as intended.

In Step S119, the microcontroller 63 discards the incomplete data, if any, at the end of Stream A and/or at the beginning of Stream B. As a result, only decodable data of Stream B will be processed after that.

In the next step S120, the stream splitting section 64 generates a video elementary stream for Stream B, and the video decoder 66 decodes and plays back that video elementary stream.

According to this processing procedure, even if one stream has been switched into another, the playback can be continued with the occurrence of decoding errors avoided by locating the connection point accurately and with the disturbance on the screen minimized.

In the preferred embodiment described above, only one TS is supposed to be stored on the hard disk 61 and includes the two ranges of TS-A and TS-B. However, the present invention is applicable in quite the same way to even a situation where a plurality of TS are stored on the hard disk 61 and need to be played back continuously. That is to say, the TS-A and TS-B described above may be two independent data streams. Also, if the TS-A is regarded as a portion of one independent data stream and the TS-B a portion of another independent data stream, then the present invention is also applicable in quite the same way to even a situation where a plurality of TS are stored on the hard disk 61 and respective portions of those TS need to be played back continuously.

Also, in the preferred embodiment described above, the presentation of the TS-B is supposed to start with an I-picture. However, the presentation may also start with any picture other than the I-picture. For example, if the presentation starts with the P-picture 57 shown in FIG. 5, then only the data of the I-picture 54 and P-picture 57 needs to be decoded but the data of the other intervening pictures preceding the picture to present (e.g., the B-pictures 55 and 56 in the example shown in FIG. 5) does not have to be decoded. It should be noted that before and after the connection point of two streams, the data of just one type of pictures (e.g., I-pictures) may be sequentially connected and played back (i.e., an I-only special playback process may be carried out).

Also, in the preferred embodiment described above, as to a transport stream that has been compressed so as to comply an MPEG standard, dummy packets and sequence error data, compliant with that standard, have been described with their specific values given. However, the present invention is in no way limited to those specific values but any other values may be used as well. Optionally, even a data stream compliant with any other standard may be adopted, too. In that case, the error code and other codes of that standard may be used as the sequence error data value and other values.

Furthermore, the data stream does not have to be stored on a storage medium. The present invention is also applicable to even a situation where a digital broadcast using TS is being received in real time, for example. In that case, the dummy packet may be inserted where the channels of the digital broadcasting are switched.

The playback function of the data processor may be carried out on a computer program that defines the processing procedure shown in FIG. 11. That is to say, a computer including the data processor can operate the respective components of the data processor and perform the processing described above by executing such a computer program. The computer program may be stored on a storage medium such as a CD-ROM and put on the market or downloaded via telecommunications lines such as the Internet. Then, a computer system may operate as a player having the same function as the data processor described above.

### INDUSTRIAL APPLICABILITY

The present invention provides a data processor, which can play back a number of data streams continuously, even when one of them has to be switched into another, with the occurrence of decoding errors avoided by detecting their connection point accurately and with the disturbance on the screen minimized.

1. A data processor for playing back a content while acquiring a data stream including content data,
the data stream being consisted of a plurality of packets, each said packet including the content data and an identifier to show the type of the content data, a portion of the content data corresponding to the top of a playback unit having a header showing the identity of the playback unit,
the data processor comprising:
a stream extracting section for acquiring a first data stream and then a second data stream;
a packet inserting section, which makes a dummy packet, having a dummy identifier that is different from any of the identifiers of the packets, and which inserts the dummy packet between the last packet of the first data stream and the first packet of the second data stream;
a splitting section for splitting the content data into respective types according to the identifiers and inserting error data, which is different from the content data, upon the detection of the dummy identifier; and
a decoder, which plays back the content data on the basis of the playback unit and, on detecting the error data, discards incomplete content data at the end of the first data stream and a portion of the content data of the second data stream up to the first header thereof such that those content data are not played back.

2. The data processor of claim 1, wherein an error code, representing an error, is predefined for the data stream, and
wherein the splitting section inserts the error code as the error data.

3. The data processor of claim 2, wherein the splitting section further inserts a bit string of zeros having a predetermined length as the error data, and
wherein when detecting one of the error code and the bit string, the decoder determines that the error data has been detected.

4. The data processor of claim 2, wherein the data representing the content has been encoded by a variable length coding technique and is included in the data stream, and
wherein the splitting section inserts a bit string, of which the bit length is equal to or greater than a maximum code length used in the variable length coding technique.

5. The data processor of claim 4, wherein the content at least includes video, and
wherein the splitting section inserts a bit string, of which the bit length is equal to or greater than a maximum code length used in the variable length coding technique for video.

6. The data processor of claim 1, wherein the stream extracting section acquires the first and second data streams, each being consisted of transport stream packets.

7. The data processor of claim 1, wherein the stream extracting section acquires mutually different portions of a single data stream, representing the same content, as the first and second data streams, respectively.

8. The data processor of claim 1, wherein the stream extracting section acquires the first and second data streams from a storage medium.

9. The data processor of claim 1, wherein the stream extracting section acquires the first and second data streams that have been broadcast.

10. A data processing method for playing back a content while acquiring a data stream including content data,
the data stream being consisted of a plurality of packets, each said packet including the content data and an identifier to show the type of the content data, a portion of the content data corresponding to the top of a playback unit having a header showing the identity of the playback unit,
the method comprising the steps of:
acquiring a first data stream and then a second data stream;
making a dummy packet, having a dummy identifier that is different from any of the identifiers of the packets;
inserting the dummy packet between the last packet of the first data stream and the first packet of the second data stream;
splitting the content data into respective types according to the identifiers;
inserting error data, which is different from the content data, upon the detection of the dummy identifier;
playing back the content data on the basis of the playback unit; and
discarding incomplete content data at the end of the first data stream and a portion of the content data of the second data stream up to the first header thereof on detecting the error data.

11. The data processing method of claim 10, wherein an error code, representing an error, is predefined for the data stream, and
wherein the step of inserting the error data includes inserting the error code as the error data.

12. The data processing method of claim 11, wherein the step of inserting the error data further includes inserting a bit string of zeros having a predetermined length as the error data, and
wherein the step of discarding includes determining that the error data has been detected on detecting one of the error code and the bit string.

13. The data processing method of claim 11, wherein the data representing the content has been encoded by a variable length coding technique and is included in the data stream, and
wherein the step of inserting the error data includes inserting a bit string, of which the bit length is equal to or greater than a maximum code length used in the variable length coding technique.

14. The data processing method of claim 13, wherein the content at least includes video, and
wherein the step of inserting the error data includes inserting a bit string, of which the bit length is equal to or greater than a maximum code length used in the variable length coding technique for video.

15. The data processing method of claim 10, wherein the step of acquiring includes acquiring the first and second data streams, each being consisted of transport stream packets.

16. The data processing method of claim 10, wherein the step of acquiring includes acquiring mutually different portions of a single data stream, representing the same content, as the first and second data streams, respectively.

17. The data processing method of claim 10, wherein the step of acquiring includes acquiring the first and second data streams from a storage medium.

18. The data processing method of claim 10, wherein the step of acquiring includes acquiring the first and second data streams that have been broadcast.
